(19) United States
(12) Patent Application Publication
(10) Pub. No.: US 2002/0060129 A1
(43) Pub. Date: May 23, 2002

(54) Apparatus and method for feeding and separating items

(76) Inventors: Clayton C. Cooper III, Clifton Park, NY (US); Joseph M. DuJack, Latham, NY (US)

Correspondence Address: HOFFMAN WARNICK & D'ALESSANDRO, LLC, 3 E-COMM SQUARE, ALBANY, NY, 12207

(21) Appl. No.: 10/003,963

(22) Filed: Oct. 31, 2001

Related U.S. Application Data
(60) Provisional application No. 60/245,781, filed on Nov. 3, 2000.

(51) Int. Cl. B65G 47/12

(52) U.S. Cl. 198/443

(57) ABSTRACT

An apparatus and method for feeding and separating a plurality of items from a random accumulation of the items. The apparatus comprises a first hopper for holding the plurality of items in the random accumulation; a hopper conveyor to discharge items from the first hopper in a first group; a first transfer that receives the items in the first group; a second hopper that receives the items from the first transfer; a metering conveyor that meters the items from the second hopper into a second group; a second transfer that receives the items from the metering conveyor; and a plurality of sequential separating conveyors that receive the second group of items and separates the items. The method includes the steps of controllably feeding the items from the random accumulation in a first grouping; metering the items from into a second grouping; and feeding the items through a series of conveyors to separate the items and orient the items to a predetermined position at discharge.

This application claims priority to U.S. provisional patent application serial no. 60/245,781, filed Nov. 3, 2000 under 35 U.S.C. §119(e).

### BACKGROUND OF THE INVENTION

1. Technical Field

The present invention relates generally to feeding items, and more particularly to an apparatus and method for feeding and separating items from a random accumulation.

2. Related Art

All matter of goods or products must be packaged for sale. Many machines and methods have been developed to feed individual items into packages. These machines oftentimes require that the items be previously separated. In many instances, however, items are provided in a bulk, random accumulation. Exemplary items commonly provided in bulk, random accumulations include: pouches, packets, bags, packages, parcels, sacks, parts, food products such as donuts, rolls, and other baked goods either in frozen or non-frozen form. One particular example of such an item is a hardware package provided with unassembled furniture. When items such as those above are packaged, they must be manually separated and placed in an appropriate package, which is time consuming, labor intensive and expensive. Because separation from a random accumulation may also be difficult, errors in packaging may result.

In view of the foregoing, there is a need in the art for an apparatus and method for inexpensively and accurately feeding and separating items from a random accumulation.

### SUMMARY OF THE INVENTION

In accordance with the present invention, there has been devised a unique, rapid and accurate method and apparatus for the storage in bulk form, dispensing from bulk, transferring, metering, separating into a single stream, orienting and sequencing into a subsequent operation or system for pouches, packets, bags, packages, parcels, sacks, parts, food products such as donuts, rolls, and other baked goods either in frozen or non-frozen form.

In a first aspect of the invention is provided an apparatus for feeding and separating a plurality of items from a random accumulation of the items, the apparatus comprising: a first hopper for holding the plurality of items in the random accumulation; a hopper conveyor to discharge items from the first hopper in a first group; a first transfer that receives the items in the first group; a second hopper that receives the items from the first transfer; a metering conveyor that meters the items from the second hopper into a second group; a second transfer that receives the items from the metering conveyor; and a plurality of sequential separating conveyors that receive the second group of items and separates the items.

In a second aspect of the invention is provided a method of separating items provided in a random accumulation into individual spaced items, the method comprising the steps of: controllably feeding the items from the random accumulation in a first grouping; metering the items from into a second grouping; and feeding the items through a series of moving conveyors to separate the items and orient the items to a predetermined position at discharge.

A third aspect of the invention is directed to an apparatus for separating a plurality of items, the apparatus comprising: a plurality of conveyors for carrying the plurality of items, wherein each conveyor is positioned below and at an angle relative to a preceding conveyor and each conveyor advances at a rate faster than a preceding conveyor, whereby the items are separated as the items advance along the plurality of conveyors.

The foregoing and other features and advantages of the invention will be apparent from the following more particular description of preferred embodiments of the invention.

### BRIEF DESCRIPTION OF THE DRAWINGS

The preferred embodiments of this invention will be described in detail, with reference to the following figures, wherein like designations denote like elements, and wherein:

FIG. 1 shows a side view of the apparatus in accordance with the invention;

FIG. 2 shows a side view of a main hopper and a first transfer of the apparatus of FIG. 1;

FIG. 3 shows a plan view of the components shown in FIG. 2;

FIG. 4 shows a rear view of the main hopper;

FIG. 5 shows a plan view of the apparatus of FIG.1;

FIG. 6 shows a side view of a metering conveyor and a second hopper of the apparatus of FIG. 1;

FIG. 7 shows a side view of a separating conveyor system; and

FIG. 8 shows a plan view of the conveyor system of FIG. 7.

### DESCRIPTION OF THE PREFERRED EMBODIMENTS

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of the preferred embodiment.

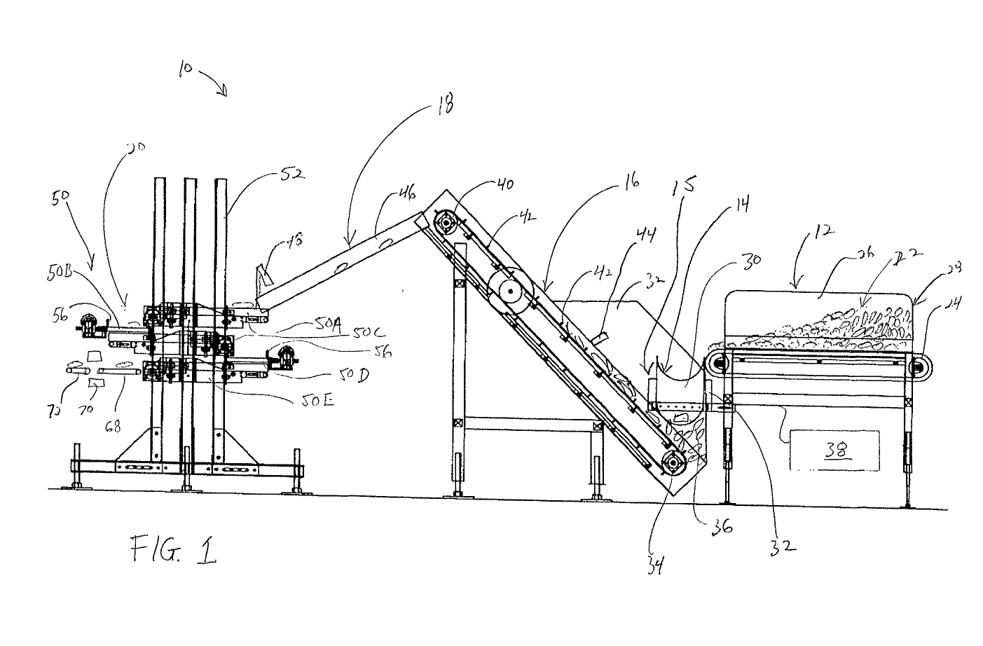

Referring to FIG. 1, an apparatus 10 for feeding and separating items from a random accumulation in accordance with the invention is shown. Apparatus 10 will be described in terms of feeding and separating “items” from a bulk, random accumulation. “Items” as used herein may refer to any manner of object that is packaged. Preferably each item is substantially identical to another and are chosen from the group comprising: pouches, packets, bags, packages, parcels, sacks, parts and food products. Food products may be, for example, donuts, rolls, and other baked goods either in frozen or non-frozen form. It should be understood that the apparatus may be applied to practically any item requiring packaging. The particular apparatus 10 described is for pouches such as those used for microwave popcorn.

Apparatus 10 generally includes a first or main hopper 12, a first transfer 14, a second hopper 15, a metering conveyor 16, a second transfer 18 and a separating conveyor system 20.

Items 22 are first placed in a completely random accumulation into main hopper 12. For instance, items 22 may be dumped into main hopper 12 from small cases. Main hopper 12 holds the plurality of items 22 in the random accumulation. A bottom portion of main hopper 12 includes a hopper conveyor 24 to discharge items from main hopper 12 in a first group, e.g., approximately three or more. Sides of main hopper 12 may be formed by a pair of opposing and substantially vertical walls 26. A receiving end 28 of main hopper 12 may be open so as to receive some form of an item feeder such as a conveyor, chute, etc., or may be closed off by another substantially vertical wall (not shown). Preferably, an upper end of main hopper 12 is open for easy access.

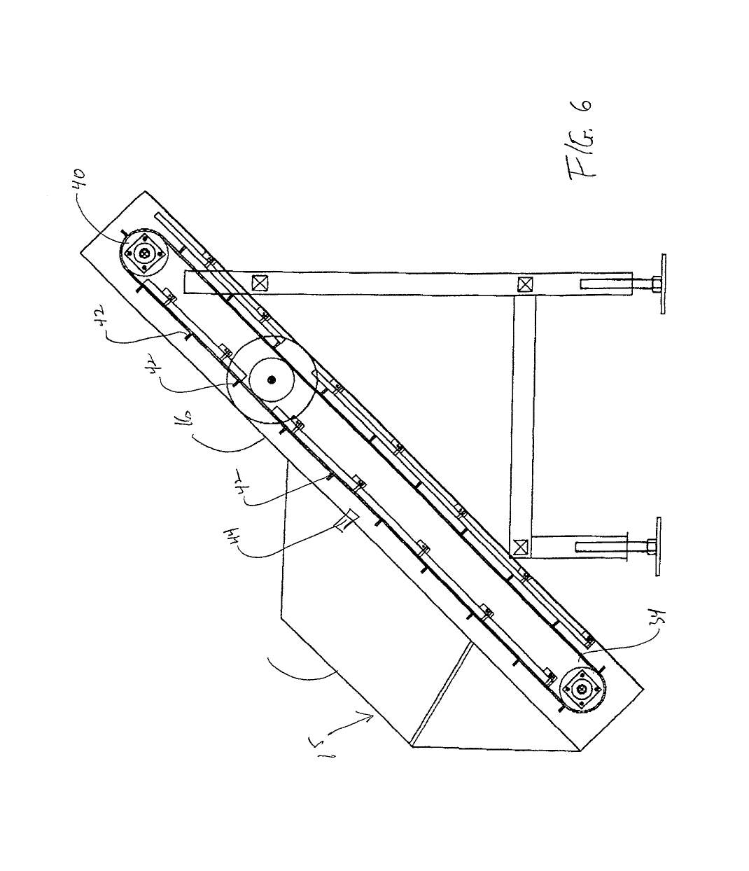

A first transfer 14 receives items 22 in the first group. First transfer 14 preferably is in the form of a chute 30 that may be angled downwardly towards second hopper 15. Chute 30 is preferably arcuate in cross-section having a length greater than its width. As an alternative, first transfer 14 may be a conveyor (not shown) or a flat slide (not shown). Second hopper 15 is preferably configured in the form of at least two substantially vertical walls 32 that enclose a first end 34 of the metering conveyor 16. A third substantially vertical wall 33, shown in FIG. 5, may also be provided to prevent items 22 from falling from metering conveyor 16.

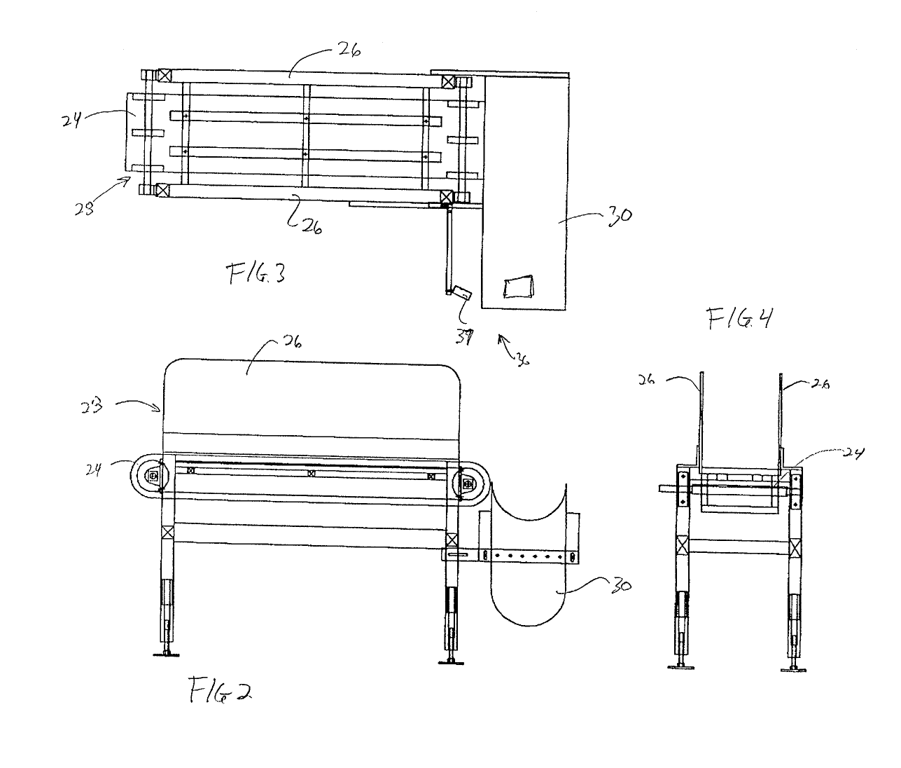

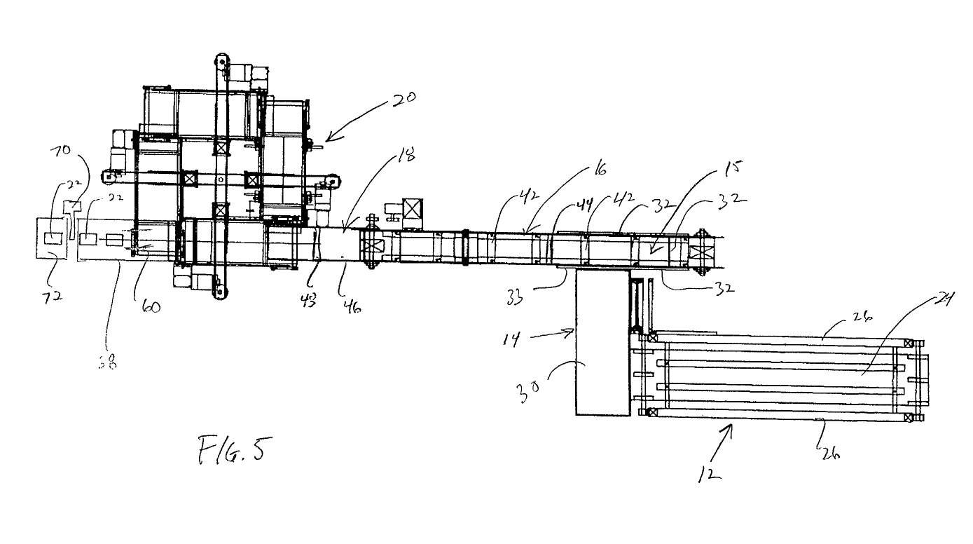

First transfer 14 also preferably includes a sensor 36 capable of determining the level of second hopper 15. As second hopper 15 fills, items 22 will back up onto first transfer 14, hence, indicating to sensor 36 that second hopper 15 is full. As shown in FIG. 3, sensor 36 may be of infared sensor including an emitter 37 and receiver 39. Of course, any sensor 36 capable of determining the presence or absence of an item may be used. Sensor 36 is electrically coupled to a controller 38 that, inter alia, controls operation of hopper conveyor 24. In this way, feeding of items 22 in a first group from main hopper 12 to second hopper 15 via first transfer 30 can be controlled. In a preferred embodiment, controller 38 is a standard system controller such as that might be provided by Allen-Bradley or GE-Fanuc.

Turning to FIGS. 1 and 6, metering conveyor 16 preferably includes a first end 34 that runs through second hopper 15 and a second end 40 placed at a height greater than first end 34.

In addition, metering conveyor includes flights 42 that support items 22 as they are conveyed upward. Although the angle of metering conveyor 15 may changed depending on the item 22 being conveyed, a preferably setting is at approximately a 45 degree angle. As items 22 are conveyed upwardly by metering conveyor 16, the items are reduced in number to a second group, e.g., approximately three or less, by the vertical face of flights 42. As items 22 are conveyed upward, any items 22 that are not supported by a flight 42 will slide back towards second hopper 15 until contacting a flight face. As items 22 are conveyed away, sensor 36 becomes unblocked indicating to controller 38 to turn on hopper conveyor 24. Metering conveyor 16 may also include a skimmer 44 positioned to block progress of more than approximately three items 22 per flight.

Referring to FIGS. 1 and 5, second transfer 18 is provided between metering conveyor 16 and separating conveyor system 20. Second transfer 18 is preferably attached to second end 40 of metering conveyor 16 and to a first separating conveyor 50A of separating conveyor system 20. Second transfer 18 may be very similar to first transfer 14. In particular, second transfer 18 preferably is in the form of a chute 46 that may be angled downwardly. Chute 46 is preferably arcuate in cross-section having a length greater than its width. As an alternative, second transfer 18 may be a conveyor (not shown) or slide (not shown). A skimmer 48 may be provided to prevent progress of more than one item at a time from second transfer 18. In a preferred embodiment, second transfer 18 provides items 22 to separating conveyor system 20 non-oriented and non-separated. As an alternative, second transfer 18 may direct items 22 to separating conveyor system 20 in a predetermined orientation. For example, depending on item 22, second transfer may orient items 22 to enter separating conveyor system 20 longitudinally and laying flat, i.e., with a short side of item 22 entering separating conveyor system 20 first. This predetermined orientation may be achieved by the shape of second transfer 18. For example, a cross section having a particular arc may direct items 22 to the predetermine orientation.

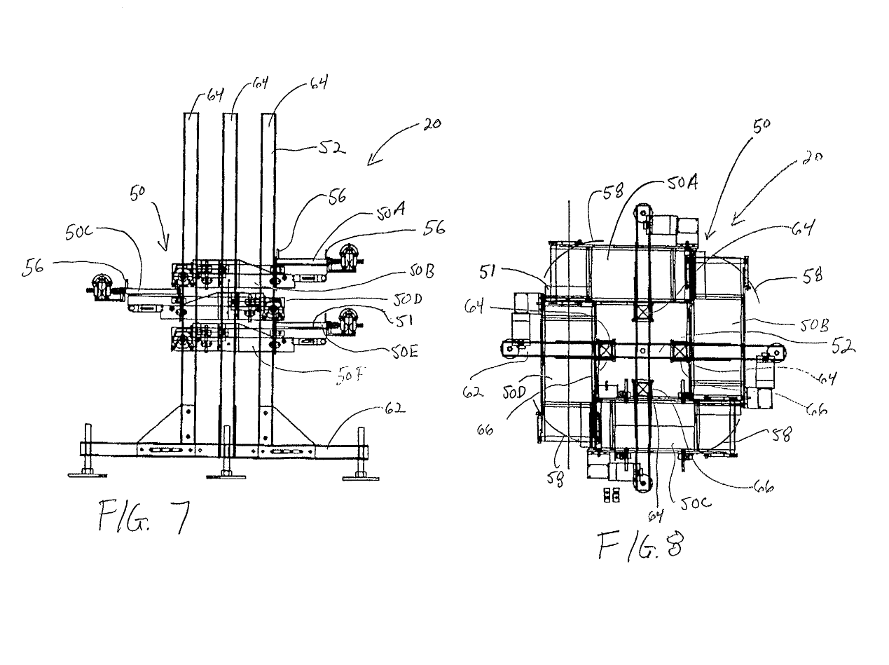

Turning to FIGS. 7 and 8, a separating conveyor system 20 in accordance with the invention is shown in greater detail. Separating conveyor system 20 includes a plurality of sequentially positioned conveyors 50. Each conveyor 50 preferably has a belt made of a material having a low coefficient of friction. In a preferred embodiment, conveyors 50 are positioned in a downwardly spiraling configuration. In particular, conveyors 50 are positioned on a support 52 such that each subsequent conveyor is positioned slightly lower than the preceding conveyor and are set at right angles to one another. For instance, in FIG. 1, separation conveyor 50A receives items 22 from second transfer 18 and outputs to separation conveyor 50B, which is set below separation conveyor 50A and at a right angle thereto. An input end of each separation conveyor is preferably positioned such that it receives the output of a preceding separation conveyor. This positioning is repeated for each subsequent conveyor. In FIG. 1, five separation conveyors 50A, 50B, 50C, 50D and 50E are provided. In FIG. 7, six separation conveyors 50A-50F are provided. In accordance with the invention, any number of separation conveyors may be provided. The number used may depend, for instance, on the physical nature of items 22 being separated and their interaction with apparatus 10. Further, the number of conveyors used may depend on the desired output rate and the desired output direction relative to the input direction of separating conveyor system 20.

At each exchange, a greater separation is created from item to item, hence, producing separation and singulation of items. Separation and singulation is also fostered by way of items 22 being turned as they pass through separation conveyor system 20. The output of separation conveyor system 20 is a stream of items 22 in a non-overlapped and separated fashion, i.e., singular items 22 with substantially equal spacing therebetween. If desired, separation and singulation may be further controlled by providing a speed differential between individual separating conveyors 50A-50F. In particular, one preferred differential rate from conveyor to conveyor that has been found advantageous is a progressive increase in speed from first separating conveyor 50A to last separating conveyor 50E, 50F.

To prevent items 22 from being ejected from conveyors 50A-50F, at least one containment rail 56 is preferably mounted proximate at least one edge of each separation conveyor 50A-50F. As shown in FIG. 8, at the juncture of adjacent separation conveyors 50A-50F, i.e., where one separation conveyor feeds to a subsequent separation conveyor, a curved containment rail 58 may be mounted to further prevent item 22 ejection. Containment rails 56, 58 also function to orient each item 22 because of the centrifugal force applied to each an item 22 forces it against rails 56, 58. In addition, inclined drop plates 51, shown in FIGS. 7 and 8, may also be provided to prevent damage to items 22 as they transition from one separation conveyor to another.

In addition to separation created by separation conveyors being set at right angles to one another, each conveyor 50A-50F may advance at a faster rate than an immediately preceding conveyor, which may further improve separation control.

With further regard to support 52, the construction preferably provides for vertically and horizontally adjustable support for separation conveyor system 20 and each separation conveyor 50A-50F. In a preferred embodiment, support 52 includes a base 62 and four substantially vertical support posts 64 to which separation conveyors 50A-50F are mounted. Clamps 66 mount separation conveyors 50A-50F to support posts 65 and provide for vertical adjustment along support posts 64 and horizontal position adjustment of each separation conveyor 50A-50F.

With further regard to controller 38, the activation and speed of each conveyor of apparatus 10 may be controlled by controller 38, i.e., hopper conveyor 24, metering conveyor 16 and every separation conveyor 50A-50F. As known in the art, each conveyor 24, 16, 50A-50F include a belt driven by one or more motors.

In accordance with the invention, a method of separating items provided in a random accumulation into individual spaced items is also provided. The method comprises the steps of: controllably feeding the items from the random accumulation in a first grouping; metering the items from into a second grouping; and feeding the items through a series of conveyors 50A-50F to separate the items and orient the items to a predetermined position at discharge. In addition, the step of feeding items 22 may further include providing each conveyor at a right angle relative to an adjacent conveyor. Furthermore, the step of feeding the items includes feeding the items through a series of progressively faster conveyors.

In operation, items 22 are provided to main hopper 12 and will begin to be fed to first transfer 14, e.g., downward angled chute 30, by hopper conveyor 24 as the demand for items 22 is received from sensor 36 by controller 38. Activation of hopper conveyor 24 is triggered by sensor 36 sensing the absence of items 22 at second hopper 15. As hopper conveyor 24 advances, items 22 enter a first end of first transfer 14 and will slide down chute 30 through gravity (or be delivered by a conveyor type first transfer 14) to a second end of first transfer 14, which feeds to second hopper 15 and first end 34 of metering conveyor 16. As items 22 arrive at first end 34 of metering conveyor 16, items 22 will fill second hopper 15 and may block sensor 36, which indicates to controller 38 to turn off hopper conveyor 24. Items 22 will then be carried away by metering conveyor 16, which is affixed with flights 42 to support items 22 as they are conveyed upward at an approximately 45 degree angle. Metering conveyor 16 reduces the number of pouches from a first group to a second group, e.g., a few per flight 42, as a result of each flight's 42 vertical face. As items 22 are conveyed upward, any items 22 that are not supported by a flight 42 will slide back towards second hopper 15 until contact with a flight 42 is achieved. As items 22 are conveyed away, sensor 36 becomes unblocked indicating to controller 38 to turn on hopper conveyor 24 so more items 22 are supplied to second hopper 15.

Items 22 are conveyed upward to second transfer 18. As items 22 arrive at second end 40 of metering conveyor 16, they will be deposited onto second transfer 18. As items 22 slide down second transfer 18, e.g., chute 46, they will align to a single stream of non-oriented and non-separated items 22. Items 22 exit second transfer 18 onto first separation conveyor 50A.

Items 22 are conveyed through the multiple separation conveyors 50A-50F with each conveyor progressively feeding the next. As items 22 are conveyed and reach the exit end of the first separation conveyor 50A, they will be deposited onto a first end of second separation conveyor 50B, which will cause separation to occur, and so on. If provided, a speed differential from separation conveyor to separation conveyor may be set based upon item 22 characteristics. In some circumstances, there may be no speed differential. As items 22 move through separation conveyor system 20, they will be separated into a single stream of non-oriented items. It should be noted that as items 22 are conveyed from conveyor to conveyor they will have a tendency to align to a more consistent orientation. Through the use of a sufficient number of separation conveyors 50A-50F, items 22 will be separated and ready to be oriented. As an alternative, separation conveyors 50A-50F may also be angled upwardly or downwardly to assist separation. That is, conveyors 50A-50F may be slanted, e.g., by adjusting clamps 66.

At the final separation conveyor 50E, 50F, items 22 may be oriented through the use of a transfer plate 60, shown in FIG. 5, set such that when an item 22 exits the final separation conveyor 50E or 50F, item 22 will be rotated to its final orientation position through the drag that occurs on the end of item 22 contacting the plate coupled with the driving force of conveyor 50E, 50F on item 22 that is being conveyed away. The combination of the two actions cause a consistent positioning of items 22.

As shown in FIGS. 1 and 5, items 22 may then be forwarded to a gapping conveyor 68, which through a controlled speed change causes each item 22 to be gapped such that a leading and trailing end can be sensed by a sensor 70. This may be a requirement of the final pitching typical to many system interfaces. In the event a pitched condition is not required then the separated and oriented condition of items 22 may be sufficient, as is, for discharge. Items 22 may also enter onto a timing conveyor 72 (FIGS. 1 and 5) where upon detection of item 22, timing conveyor 72 will alter an item 22 position such that the resultant output will be a stream of items 22 set to a consistent pitched condition. In a typical system the stream of items 22 would then be transferred in a synchronous state to a system that would either accumulate or effectively utilize the stream to complete the next operation in a production format.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

For instance, separating conveyor system 20 may, in accordance with the second preferred embodiment (not shown), provide separating conveyors such that each conveyor deposits onto the next successive conveyor in a serpentine pattern. That is, conveyors are provided vertically above one another and alternate run directions.

What is claimed is:

1. An apparatus for feeding and separating a plurality of items from a random accumulation of the items, the apparatus comprising:
a first hopper for holding the plurality of items in the random accumulation;
a hopper conveyor to discharge items from the first hopper in a first group;
a first transfer that receives the items in the first group;
a second hopper that receives the items from the first transfer;
a metering conveyor that meters the items from the second hopper into a second group;
a second transfer that receives the items from the metering conveyor; and
a plurality of sequential separating conveyors that receive the second group of items and separates the items.

2. The apparatus of claim 1, wherein operation of the hopper conveyor is controlled by a sensor monitoring a level of the second hopper.

3. The apparatus of claim 1, wherein the metering conveyor includes a first end that runs through the second hopper and a second end placed at a height greater than the first end.

4. The apparatus of claim 1, wherein the metering conveyor includes flights.

5. The apparatus of claim 4, further comprising a skimmer positioned above the metering conveyor to block progress of more than approximately three items per flight.

6. The apparatus of claim 1, wherein the first transfer is an angled chute.

7. The apparatus of claim 6, wherein the chute has a length greater than its width.

8. The apparatus of claim 6, wherein the chute is arcuate in cross-section.

9. The apparatus of claim 1, wherein the first transfer is a conveyor.

10. The apparatus of claim 1, wherein the second hopper is formed of at least two substantially vertical walls enclosing a first end of the metering conveyor.

11. The apparatus of claim 1, wherein the second transfer is a chute.

12. The apparatus of claim 11, further comprising a skimmer to prevent progress of more than one item at a time from the chute.

13. The apparatus of claim 11, wherein the chute directs the items to the plurality of separation conveyors in a predetermined orientation.

14. The apparatus of claim 13, wherein the items are pouches and the predetermined orientation is laying flat and entering the conveyors longitudinally.

15. The apparatus of claim 1, further comprising a controller that controls activation of the hopper conveyor, metering conveyor and separation conveyors.

16. The apparatus of claim 1, wherein the items are substantially identical and are chosen from the group comprising: pouches, packets, bags, packages, parcels, sacks, parts and food products.

17. The apparatus of claim 1, wherein each separation conveyor is advancing a faster rate than the immediately preceding conveyor.

18. The apparatus of claim 1, wherein the separation conveyors are positioned in a downwardly spiraling configuration.

19. The apparatus of claim 1, wherein an output of a separation conveyor feeds to an input a subsequent separation conveyor at a right angle.

20. The apparatus of claim 1, wherein the separation conveyors output the items in a non-overlapped and separated fashion.

21. The apparatus of claim 1, further comprising a vertically and horizontally adjustable support for the separation conveyors.

22. The apparatus of claim 1, further comprising a containment rail proximate an edge of each separation conveyor.

23. The apparatus of claim 22, further comprising a curved containment rail proximate the juncture of adjacent separation conveyors.

24. The apparatus of claim 22, wherein the containment rails orient each item.

25. A method of separating items provided in a random accumulation into individual spaced items, the method comprising the steps of:
controllably feeding the items from the random accumulation in a first grouping;
metering the items from into a second grouping; and
feeding the items through a series of conveyors to separate the items and orient the items to a predetermined position at discharge.

26. The method of claim 25, wherein the step of feeding the items further includes providing each conveyor at a right angle relative to an adjacent conveyor.

27. The method of claim 25, wherein the step of feeding the items includes feeding the items through a series of progressively faster conveyors.

28. An apparatus for separating a plurality of items, the apparatus comprising:
a plurality of conveyors for carrying the plurality of items,
wherein each conveyor is positioned below and at an angle relative to a preceding conveyor and each conveyor advances at a rate faster than a preceding conveyor,
whereby the items are separated as the items advance along the plurality of conveyors.

29. The apparatus of claim 28, wherein the plurality of conveyors are positioned in a downwardly spiraling configuration to reduce space requirements.

30. The apparatus of claim 28, wherein the angle is a right angle.

31. The apparatus of claim 28, further comprising a vertically and horizontally adjustable support for the conveyors.

32. The apparatus of claim 28, further comprising a containment rail proximate an edge of each conveyor.

33. The apparatus of claim 32, further comprising a curved containment rail proximate the juncture of adjacent conveyors.

34. The apparatus of claim 32, wherein the containment rails orient each item.

35. The apparatus of claim 28, wherein the items are substantially identical and are chosen from the group comprising: pouches, packets, bags, packages, parcels, sacks, parts and food products.

36. The apparatus of claim 28, wherein the plurality of conveyors output the items in a non-overlapped and separated fashion.

37. The apparatus of claim 28, further comprising an inclined drop plate between adjacent conveyors.

38. The apparatus of claim 28, further comprising a controller for controlling activation and speed of each conveyor.
